(19) United States
(12) Patent Application Publication
(10) Pub. No.: US 2008/0027814 A1
(43) Pub. Date: Jan. 31, 2008

(54) Direct incentive authentication link (DIAL) system

(76) Inventors: Michael Kulakowski, (US); Robert Kulakowski, (US)

Correspondence Address: MICHAEL KULAKOWSKI, 5 CARLSON COURT, JACKSON, NJ, 08527, US

(21) Appl. No.: 11/881,506

(22) Filed: Jul. 28, 2007

Related U.S. Application Data
(60) Provisional application No. 60/834,334, filed on Jul. 31, 2006.

(51) Int. Cl. G06Q 30/00

(52) U.S. Cl. 705/14

(57) ABSTRACT

The Direct Incentive Authentication Link System establishes a real-time direct communication link between a consumer and a product's Manufacturer, Retailer, Credit Card Company, or Distributor (referred to collectively as the “Retailers”) during the purchase process within any type of retail environment.

### RELATED APPLICATION:

The present application claims the benefit of the “Direct incentive authentication link (DIAL) system” U.S. provisional patent application No. 60/834,334 filed Jul. 31, 2006 which is incorporated herein by reference in its entirety.

### ABSTRACT

The Direct Incentive Authentication Link System establishes a real-time direct communication link between a consumer and a product's Manufacturer, Retailer, Credit Card Company, or Distributor (referred to collectively as the “Retailers”) during the purchase process within any type of retail environment.

### FIELD OF THE INVENTION

The Direct Incentive Authentication Link (DIAL) System forms a secure direct communication channel from the Retailer to a potential customer by providing an exact “Purchase Incentive Offer” that is linked to a distinct product (identified by RFID data) thereby creating an individual “direct marketing campaign” for a specific customer at a fixed point in time in a precise location by using various digital devices in a secure manner.

### BACKGROUND OF THE INVENTION

A Direct Incentive Authentication Link system's electronic connection is established between the Retailers electronic transmitting devices (within the Direct Sales Server Network) and a customer's cellular telephone (preferable embodiment) across a WI-FI wireless network within any type of retail environment. The WI-FI connection established between the Retailers transmitting device and the customer's cellular telephone employs all authentication provisions and safeguards contained within the “Secure RFID Authentication System using non-trusted communications agents” (U.S. patent application Ser. No. 11/728,792 filed by Michael Kulakowski and Robert Kulakowski).

Following the successful authentication of the customer's cellular telephone to the Direct Sales Server Network, the customer's cellular telephone serves as a “trusted device” within the Direct Sales Server Network and can access the Retailers WI-FI network for a specific time period.

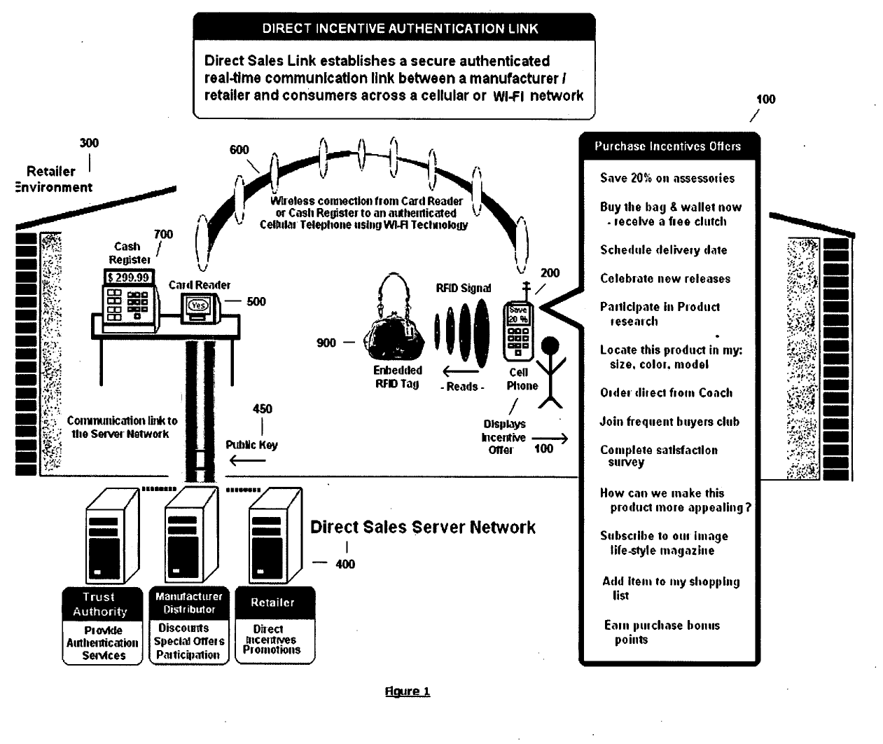

Once a DIAL link connection is established between the customer's cellular telephone and the Retailers WI-FI network (preferred embodiment (Drawings FIG. 1, #600)) subsequent customer enacted reads/scans of a product's RFID tag (Drawings FIG. 1, #900) (using their cellular telephone equipped with an RFID reader or a secure RFID reader) prior to a product's purchase authenticates that product against counterfeiting or piracy while enacting a “Cryptographic Authentication Challenge” as detailed within the “Security authentication system for collectible and consumer items” (patent application Ser. No. 11/157,282).

### BRIEF SUMMARY OF THE INVENTION

The Direct Incentive Authentication Link (DIAL) System provides the customer the opportunity to select additional services offered on behalf of the Retailer, including, but not limited to: Owner Registration, Product Delivery Scheduling, Rebate Filings, Product Service Plans, Product Performance Insurance Plans, Automatic Periodic Product Ordering Agreement, Scheduled ordering and delivery, Collateralization Services, Electronic Product Appraisal Services, External Product Appraisal Services, Product Valuation and Certification Services, Broker Services, Electronic Payment Services, etc. In a broad sense, the Direct Incentive Authentication Link (DIAL) System acts as a conduit between the Retailers and Consumers encapsulating a myriad of purchasing and post purchase services that here-to-fore were independent amongst various entities.

### DETAILED DESCRIPTION OF THE INVENTION

Once a product has successfully passed the Cryptographic Authentication Challenge (of patent application Ser. No. 11/157,282), the product is deemed “valid” and not counterfeit, not pirated and not stolen. A series of Secure Messages constituting “Incentive offers” are transmitted from the Retailers (via the Direct Sales Server Network's Trust Authority (TA)) directly to the consumer's “Trusted Device”, such as an authenticated cellular telephone (Drawings—Drawings FIG. 1 #200) (preferable embodiment), or an RFID Reader, PDA, PC, Laptop, or any other form of electronic (RFID reading or Secure ID reading) device that can be authenticated as a “Trusted Device” within the Direct Sales Server Network (Drawings FIG. 1, #400)) in an authenticated, secure fashion meeting the Trusted Devices Authentication and Security protocols (patent application Ser. No. 11/728,792 Secure RFID authentication system using non-trusted communications agents).

In this application, a reference to a cellular telephone (Drawings—Drawings FIG. 1 #200) should be considered a reference to either, but not limited to: an RFID Reader, PDA, PC, Laptop, electronic Notebook, Scanner, or any other form of electronic Trusted RFID reading device that can be accessible, communicated with, authenticated and capable of reading or interacting with any form of RFID Tag, Bar Code, Hash, Encrypted Serial Number, Electronic Product Code, Product Markup Language, and/or future product identification process.

In an optimal application, the Retailer's Incentive Offer is intrinsically linked to a specific product that is available for sale within the Retail environment. A Retailer's Incentive Offer may be transmitted to a customer's cellular telephone based upon, but not limited to the following conditions:

Customer's Net Worth

Customer's Brand Loyalty

Customer's Credit Rating

Customer's demographic factors

Value of the product to be purchase

Product Sales Promotions

Product Life Cycle Determinants

Product Launch Incentives

A reference to any Direct Incentive Authentication Link System's Offer, Purchase Incentive Offer, or Incentive Message, may be identified as an “Incentive Offer” (Drawings FIG. 1, #100) within this application.

The Incentive Offer messages are generated in “real-time” by the products Manufacturer, Retailer, Credit Card Company, Advertiser, Marketer, Broker, or Distributor individually or in unison. The Incentive Offer message is authenticated within the Direct Sales Server Network and assured of their authenticity by the Trust Authority (TA) responsible for securing and authenticating any participating entity within the Direct Sales Server Network's DIAL system.

The Trust Authority ensures that the established security, accessibility, and authenticity requirements imposed upon the following:
Manufactures
Distributors
Retailers
Credit Card Company
RFID Readers
Communication Devices
Networks
Computer Systems
Communication Links
Internal and External Data
Internal and External Messages
Internal and External Incentive Offer messages

are met and that all aspects of the DIAL application are “cryptographically authentic”, recorded, verifiable, and guaranteed.

The DIAL Incentive Offer messages are communicated directly to the consumer's Trusted electronic (RFID reading) device (preferably a cellular telephone) (Drawings FIG. 1, #200) by utilizing the following device:
Display screen,
HTTP web page
Video capacity,
Audio system,
Illumination system,
Buttons & Dials
Vibratory pattern
Text
Tones
Music
Flashing
Buzzing
Timer/Clock

(The above device “interactive or alert or prompt capacities and functions” comprises the Message Format list)

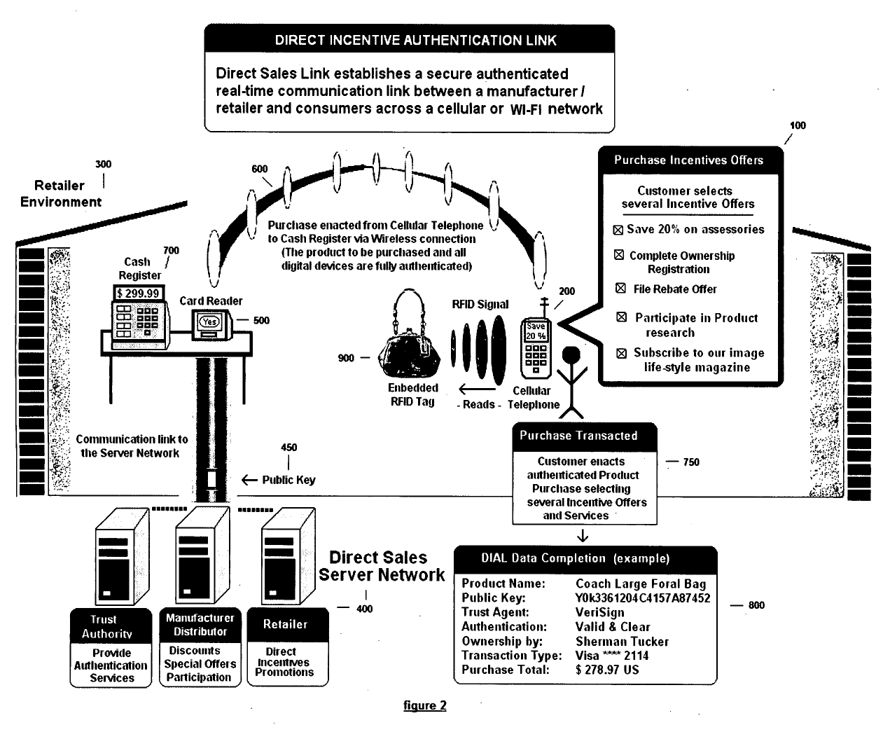

A Direct Incentive Authentication Link Offer message encapsulates the Retailers determination that the consumer purchases an authenticated product at a specific point in time, whereby the Retailer may exercise the option to rescind an Incentive Offer at any time thereafter. An Incentive Offer message bound by an ending time frame or expiration point may be presented to a user with a “count down” indicator. Should the consumer elect to accept the DIAL Incentive Offer displayed or presented on the electronic device (Drawings FIG. 1 #100) and the Trust Authority will record the Incentive Offer's ID, enactment time, and other transaction details (Drawings FIG. 2 #800) and create a binding certificate or record of the consumer's acceptance of the Incentive offer.

Upon a customer's purchase of the authenticated product, the Trust Authority will transmit to the Trusted Cash Register (Drawings FIG. 1 #700) the transactional details pertaining to the accepted Incentive Offer and the Trusted Cash Register (Drawings FIG. 1, #700) will factor into the product's total cost the net effect of the accepted Incentive Offer. The transactions details will be displayed or presented on the electronic device (Drawings FIG. 2 #800) and the Trust Authority will record the Incentive Offer's ID, enactment time, and other transaction details and create a binding certificate or record of the consumer's acceptance of the Incentive offer. The Trusted Cash Register receipt will also contain a record of the Incentive Offer and data corresponding to the Incentive Offer's authentication details and the product's authentication details. All transactions details can optionally be transferred to a customer's email account or communicated to another secure cellular telephone and/or a secure electronic device (under the auspices of the Secure RFID authentication system using non-trusted communications agents—U.S. patent application Ser. No. 11/728,792)

Specific details pertaining to either a rejected or accepted Incentive Offer may be transmitted from the Trusted Authority and/or Trusted Cash Register to the Retailers.

Should a consumer decide to reject a specific Incentive Offer, the Retailers may substitute another Incentive Offer to “sweeten the deal” and re-induce the consumer to purchase the product. Subsequent Incentive Offers will be denoted on the user's electronic device (preferably a cellular telephone) as a new Incentive Offer and be displayed using the aforementioned Message Format (Drawings FIG. 1, #100).

DIAL Incentive Offer messages may include, but are not limited to:

| | |
|---|---|
| Savings | Save 20% on this item |
| | Save 10% on associated accessories |
| Bonus | Free Item: Buy the pocketbook now & |
| | receive a free matching wallet |
| | Earn Points: Earn double bonus points for |
| | this purchase |
| Locate | Locate this product in my: |
| | Area, Size, Color, Model, etc. |
| Order | Direct from Manufacture if the desired item |
| | is not available for purchase immediately |
| | from the Retailer |
| Compose List | Add this item to my shopping/wish list |
| | Add this item to my Gift/Wedding registry |
| Invitation | Complete a product satisfaction survey |
| | Suggest how we can make this product |
| | better |
| | Join our Frequent Buyers Club |
| | Receive new product announcements |
| Enrollment | Participate in a Product Launch Celebration |
| | Subscribe to a ‘branded’ life style magazine |
| | Contribute toward Product Research & |
| | Testing |
| | Join a Product Focus Group |
| | Enroll in Product Protection/Service Plan |
| Credit Card | Increase your Credit Limit |
| | Use your Bonus Rewards toward this |
| | purchase |
| | Upgrade your Credit Card Club Level |
| | Earn Double Bonus Rewards |
| Added | Include complimentary Services with this |
| Services | purchase |

Authentication between the Manufacturer, Retailer, Credit Card Company or Distributor and the Trusted Authority is established using an encrypted communication service link (Drawings FIG. 2 #400, #450, #600) that is comprised of a unique (Manufacturer, Retailer, Credit Card Company, or Distributor) id (or an encrypted unique id) and an associated public key (Drawings FIG. 2, #450) previously provided by the Trust Agency. A real-time authentication challenge is established between the Trust Authority and the Retailers whereby the communication channel transfers a dynamic encrypted security algorithm that is cross-referenced and authenticated in either direction (Trust Authority⇄Manufacturer with Public key transferred along with unique seed id). Subsequent Incentive Offers employ this cryptographic key authentication for a predetermined duration of time. Consumer activity consistent within a shopping environment resets the cryptographic key's lifespan and is used until its expiration due to inactivity or the intentional termination of the connection by either the consumer or the Retailer. Additionally, events such as leaving a Retailer's environment or completing the transaction for the product subject to the Incentive Offer may terminate the existence of the cryptographic key.

A series of DIAL notification icons/text convey state information to the consumer's electronic device, such as, but not limited to:
Establishment of a connection to the Trust Authority
Cellular telephone or electronic device authentication by the Trust Authority
Results of a product's authentication challenge
Establishment of a Retailers connection based upon the product's public key
Authentication of the Retailer
Retrieval of the associated DIAL Incentive Offer Message(s)
The consumer's acceptance of an available DIAL Incentive Offer Message
Transfer of the Incentive Message terms to the Trusted Cash Register at the point of purchase

A secure communication link is established between the customer's authenticated cellular telephone to an authenticated Cash Register utilizing the cellular telephone's Public Key (Drawings FIG. 1, #450) obtained from the Trust Authority. When a customer accepts a previously presented Incentive Offer, the selected Incentive Offer is recorded on the—cellular telephone, Cash Register's Network, and the Trust Authority Computer System.

Should the Incentive Offer include the acquisition of a “free product” or “discounted associated item or accessory” (a Qualifying Item), the consumer will be instructed by the DIAL network via cellular telephone (preferable) as to which item is subject to the terms of the “free or discounted” Incentive Offer. In a preferred environment, the physical location of the Qualifying Item would be presented to the consumer on their cellular telephone in a GPS location matrix. Upon acquisition of the Qualifying Item, the consumer can “Read” the Qualifying Item's RFID and enact a “Cryptographic Authentication Challenge” as detailed within the “Security authentication system for collectible and consumer items” (patent application Ser. No. 11/157,282) to ensure that the Qualifying Item is neither Counterfeit, Pirated, Recalled, Previously Owned, Un-Warrantable, Un-Lawful, etc.

Alternatively, when appropriate, the consumer may elect to substitute another item (a Substituted Item) similar to the Incentive Offer's Qualifying Item and pay an additional “premium charge” above the Incentive Offer's Qualifying Item Base Price. In cases such as these, a Retailers “Qualifying Item Substitution Charge.” will be conveyed to the consumer on the consumer's authenticated cellular telephone. Should the consumer agree to pay the premium charge associated with the Substituted Item's Qualifying Item Substitution Charge, a record of the consumer's agreement to pay the Qualifying Item Substitution Charge is conveyed from the cellular telephone to the Trust Authority and the Retailer's Computer System.

Once the purchase for the qualifying product is transacted, the recorded Incentive Offer is transferred via the wireless network to the Cash Register and the cost of the product is calculated based upon the terms of the Incentive Offer.

Should the Incentive Offer include the acquisition of a “free product” or “discounted associated item or accessory”, and the consumer fails to acquire such an item, the consumer may be instructed by either the sales clerk or the DIAL network via the cellular telephone that the product to be purchased includes a “free product” and is subject to the terms of the “free or discounted” Incentive Offer. At that time, the Qualifying Item, Substituted Item, or Qualifying Item Substitution Charge as previously describe are enacted.

In instances when the Incentive Offer's Qualifying Item is unavailable within the Retailers Environment or stock, the Retailers may provide the option to send the Incentive Offer's Qualifying Item directly to the consumer's home or business address.

The Retailers may present to the consumer the option to have the Incentive Offer's Qualifying Item sent directly to their home or business address. If the consumer selects this option, the consumer is advised of any charges associated with this service and delivery details are provided.

At the point of checkout, a WI-FI direct link is established between the cellular telephone and the cash register and a bi-direction authentication process is enacted by the cellular telephone and cash register, whereby—the Trust Authority processes and evaluates the authentication strength between the two devices. In situations where the authentication strength is inefficient to assure 100% security against fraud or malevolent activity, the Trust Authority may intervene and prevent the purchase transaction from being completed. An example of a compromised Purchase Transaction centers upon the unknown theft of a DIAL accessible cellular telephone and the user's inability to pass the Cellular Telephone usage security challenge and the requirements of the (user personal identification number “PIN” or biometric) Purchase Authentication System. In instances when a DIAL authenticated cellular telephone is considered compromised, the Trust Authority will block further transactions from being conducted by the compromised cellular telephone and report such incidences to the registered owner of the cellular phone, their assignees, Telephone Security Departments, or local Law Enforcement Authorities.

Purchase Transactions—are conducted using an authenticated cellular telephone linked securely and wirelessly to an authenticated Credit Card Reader (Drawings FIG. 1 #500) and/or Cash Register (Drawings FIG. 1 #700). A DIAL Transaction Key comprises a single unique “transaction id” based upon the DIAL System's acknowledgement of the cellular telephone's public key, Cash Register's public key, Credit Card Reader's public key, Credit Card Authentication key, and the item's RFID public key (Drawings FIG. 1 #450) that is being purchased. The DIAL Transaction Key is used to track and identify all aspects of the transactions such as: the Customer's Identification, Cash Register, Reader, the cellular telephone used, and the product to be purchased. Subsequent customer service requests will utilize the DIAL Transaction Key to perform the necessary customer service actions.

Purchase Transactions of authenticate purchased product are electronically recorded within the Direct Sales Server Network's database and the customer may be provided with an acknowledgement notice.

Credit Card Transactions—are permitted and completed only after a Credit Card customer's identity has been confirmed through a combination of several methods, including, but not limited to:
User name and Password entry
Personal Identification Number entry
Answering a series of personal biographic questions
Voice Speech Pattern Recognition
Finger Print Recognition
Iris Recognition

Once a Credit Card customer's identity has been successfully authenticated and the account status has been confirmed as active and in good standing, the monetary impact of the purchase transaction is evaluated to insure that the Credit Card customer's maximum credit limit is not exceeded. If the pending transaction's impact is within the Credit Card customer's credit limit, a secure wireless transaction is conducted between the Credit Card customer's authenticated cellular telephone and the authenticated Cash Register. Where the pending product purchase causes the customer's credit balance to be exceeded, the Credit Card Company may intervene and provide an Incentive Offer to the customer to “increase their credit limit” or enroll in some other Credit Card Credit program.

When the customer's credit balance and credit transaction is approved and transacted by the Credit Card Company, a Cash Register's DIAL Transaction Receipt is produced containing the DIAL Transaction ID and the appropriate item details. Also, the Credit Card customer may choose to capture an electronic form of the Cash Register receipt on their cellular telephone. In this case, the authenticated Cash Register electronically transfers the DIAL Transaction Receipt directly to the cellular telephone's Purchase Receipt Log. Credit Card Transactions for the purchase of authenticated purchased product are electronically recorded within the Direct Sales Server Network's database and the customer may be provided with an acknowledgement notice.

Electronic Ownership Registration—of the purchased product is automatically established once a DIAL Transaction has been completed provided the customer has elected to “Automatically Complete Electronic Ownership Registration”. Electronic Ownership Registration establishes an irrefutable “Chain of Ownership” between the authenticated customer, the Retailer, and the authenticated product and any associated “free” products associated with the product that was purchased. The Trust Authority may issue either an electronic or paper based “Certificate of a Product's Authenticity and Ownership Confirmation” confirming that the authenticated customer had indeed purchased the given product and the product was “authenticated” and deemed “valid” and not counterfeit, not pirated, not stolen, and subject to all “ownership rights” of the purchased product offered by the Retailer, Manufacture, Distributor, or some other entity. Establishment of Electronic Ownership of authenticated purchased products is digitally recorded within the Direct Sales Server Network's database and the customer may be provided with an acknowledgement notice. In instances when an Electronic Ownership Registration had not been created at the point of a product's purchase, the customer may complete the Electronic Ownership Registration process by reading the products RFID tag with their cellular telephone and once authenticated by the Trust Authority, complete the Electronic Ownership Registration process. Establishment of an Electronic Ownership Registration of an authenticated purchased product is digitally recorded within the Direct Sales Server Network's database and the customer may be provided with an acknowledgement notice.

Electronic Completion and Electronic Filing of Rebates are automatically completed on behalf of the DIAL customer and transmitted electronically to the Rebate Offering Entity. The electronic rebate filed will contain the appropriate details of the qualifying product's transaction including, but not limited to:
Product Name
Product Model
Product Serial #
Product Public Key
Rebate Offer Name
Rebate Offer ID
Rebate Filing Date
Rebate Start Date
Rebate Expiration Date
Rebate Amount
Rebate Currency
Purchaser's Name
Purchaser's Address
Purchasers Contact Information
Purchaser's Authenticated ID
Purchaser's Public Key

Following the successful transfer of an Electronically Filed Rebate and the reception of a Rebate Filing acknowledgement for the responsible entity, a confirmation email or a confirmation cellular telephone message in the appropriate Message Format is communicated to the customer. Also, a copy of the electronically filed Rebate may be emailed to the customer and/or recorded on the customer's cellular telephone's “Filed Rebate” listing. Establishment of an Electronic Completion and Electronic Filing of Rebates of authenticated purchased products are digitally recorded within the Direct Sales Server Network's database and the customer may be provided with an acknowledgement notice.

Product Delivery Scheduling—Immediately after the completion of an authenticated product purchase, the Retailer may present to the customer the opportunity to select a Delivery Date and Time for the delivery of the purchased product (eg. for non carry-out products such as large electronics, furniture, etc.). Alternatively, the Retailer may present to the customer the ability to select a dependable commercial delivery service (UPS, FedEx, DHL, etc.) for the purchased product or the details to pick-up the purchase product at a location convenient to the customer.

Once the delivered product is received by the customer, the product may be authenticated by a customer's authentication challenge (utilizing the Trust Agency's public key data) to insure the customer receives the appropriate product that was authenticated and recorded as the purchased product.

The Retailer may extend post purchase Incentive Offers directly to the customer's cellular phone to coincide with the delivery of the recently delivered product.

Establishment of an authenticated purchased product's Product Delivery Scheduling or its eventual delivery is digitally recorded within the Direct Sales Server Network's database and the customer may be provided with an acknowledgement notice.

Product Service Plans—Immediately after the completion of an authenticated product purchase, the Retailer or a Service Provider may present to the customer the opportunity to enroll in a Product Service Plan. An example of such a Product Service Plan centers upon the purchase of a ‘Grand Father Clock’ that requires periodic tuning. In this case, the Product Service Plan would allow for a customer to enter into such a service contract. Establishment of a Product Service Plan of authenticated purchased products is digitally recorded within the Direct Sales Server Network's database and the customer may be provided with an acknowledgement notice.

Product Performance Insurance Plans—Immediately after the completion of an authenticated product purchase, the Retailer or an Insurance Provider may present to the customer the opportunity to enroll in a Product Performance Insurance Plan. An example of such a Product Performance Insurance Plans applies to the purchase of a ‘Washing Machine’ whereby the customer may enhance or extend the Manufacturer's Warranty with a Product Performance Insurance Plan that guarantees repair or replacement of the Washing Machine over an extended period. Establishment of a Product Performance Insurance Plan of authenticated purchased products is digitally recorded within the Direct Sales Server Network's database and the customer may be provided with an acknowledgement notice.

Automatic Periodic Authenticated Product Ordering Agreement—

The customer may place an order for: a product to be included within an upcoming new release model of that product, or for a product to be part of a new product line, or for a product that is scheduled to be available in a future release, provided that any such ordered product meets all existing and expanding authentication requirements to guarantee the pedigree of the product against counterfeiting and piracy practices in conformance to the safeguards entailed within “Security authentication system for collectible and consumer items” (patent application Ser. No. 11/157,282).

An example of a product that customers may enroll in Automatic Periodic Product Ordering program may consist of the future release and purchase availability of Holiday-Ornaments from a certain Manufacturer, Artistic painting, Dinnerware, Jewelry, or decorative seasonal accessories belonging to a specific series, etc. Prior to the product's shipment, the customer will receive from the Trust Authority an Authentication Statement and a Certificate of Authenticity Notification for the ordered product. At that point, the customer may elect to “authorize” the fulfillment of the ordered authenticated product as per the terms of Automatic Periodic Authenticated Product Ordering Agreement, or cancel the order. The Establishment of Automatic Periodic Authenticated Product Ordering Agreement contracts for the specified product's future release is digitally recorded within the Direct Sales Server Network's database and the customer may be provided with an acknowledgement notice.

Collateralization Services—Prior to or after the purchase of a valuable authenticated product purchase, the customer may elect to leverage the accumulated value of their previously purchased products, by electing to “collateralize” their previous purchased products (effectively receiving a “short term loan”) as a portion of payment or payment for the ‘pending, new or recently’ purchased authenticated product. An example of Collateralization Services Offer provides a customer with a “short term” loan based upon their existing ownership of Thomas Kinkade Paintings toward the purchase of the newest addition to their Kinkade collection. The customer's ownership of the new Kinkade painting thereby increases the value of their previously acquired Kinkade collection and is suitable for future evaluation and Collateralization. Performance of Collateralization Service of authenticated purchased products is digitally recorded within the Direct Sales Server Network's database and the customer may be provided with an acknowledgement notice.

The customer may then elect to have their entire Thomas Kinkade Painting Collection appraised by the DIAL System's Electronic Product Appraisal Services (described below).

Electronic Product Appraisal Services—Prior to or after the completion of an authenticated product purchase, the customer may elect to have their newly purchased product Electronically Appraised—when appropriate. The Product Appraisal Service will determine the “approximate worth” of the purchased product based upon the ‘prevailing Appraisal Authorities’ that are reliable, trusted and authenticated associates or affiliates of the DIAL System. The customer may choose to accept a number of additional services, including, but not limited to: Issuance of an Official Product's Appraisal Certificate, Electronic Appraisal Record, or Blanket Portfolio Appraisal Service requests by a recognized approved authorized entity within a specific field. An example of an Electronic Product Appraisal Service consists of a customer's purchasing an authenticated rare Musical Instrument that has an existing appraised value by an acknowledged ‘trusted’ reputable Appraisal firm that is available for purchase by the customer. Furthermore, the customer may purchase a Blanket Portfolio Appraisal of their entire rare musical collection by authorizing the DIAL System to forward to the authenticated Appraisal firm (selected by the customer) the necessary data records of previously purchased (rare musical instrument) products that have been registered within their DIAL System's Electronic Ownership Registration Facility directly to the Appraisal firm for evaluation/appraisal purposes. Performance of Product Appraisal Services of authenticated purchased products is digitally recorded within the Direct Sales Server Network's database and the customer may be provided with an acknowledgement notice.

External Product Appraisal Services—customers of the DIAL system may schedule an “Appraisal Service Appointment” to appraise their valuable possessions that were not purchased under the secure authentication rubric of the DIAL system. Typically, a user brings a valuable item to a DIAL approved and affiliated Appraisal service and a certified appraiser then researches, calculates, and determines the appropriate current “market value” (valuation) of the item at that time. Also, a check of the items serial number/model number, etc. against existing “stolen property” listings maintained by law enforcements authorites may alleviate possible ownership challenges. Should the item be considered “not stolen, not illegally obtained, or not illegal in nature, or not defective or recalled”, an RFID tag conforming to the DIAL system safeguards as detailed within a “Security authentication system for collectible and consumer items” (patent application Ser. No. 11/157,282) is then inserted within or attached permanently to the item (Drawings FIG. 1 #900). The RFID tag is inserted or attached to the item (Drawings FIG. 1 #900) using a superior adhesive that renders the RFID tag inoperative should an individual attempt to remove the tag from the recently appraised item. The newly inserted or attached RFID tag is armed with the public/private key encryption mathematical algorithms obtained from the Trust Agency that establish the authenticity of the item to the DIAL network. The detailed description of the item, digital pictures of the item, research methodology, calculation and valuation, or other specific item details may be stored within the DIAL system for future usage. A confirmation notice is distributed from the Trust Agency to the Appraiser and Consumer indicating the successful induction of the item into the DIAL network.

All previously discussed DIAL authentication routines and DIAL services are enacted upon the newly appraised item regarding the newly attached RFID tag such as, but not limited to: Owner Registration, Rebate Filings, Product Service Plans, Product Performance Insurance Plans, Automatic Periodic Product Ordering Agreement, Collateralization Services, Product Valuation and Certification Services, Broker Services, Electronic Payment Services, etc. Administration of an External Product Appraisal Services to an item that applies DIAL system authentication safeguards is digitally recorded within the Direct Sales Server Network's database and the customer may be provided with an acknowledgement notice.

Product Valuation Certificates and Product Ownership Certificates Services—A customer of an authenticated purchased product using the services provided by the DIAL System may order a specific Product Valuation Certificate be emailed or sent directly to products owner from the Trust Authority. Also, a Product Ownership Certification may be similarly ordered. Customer Requests for Product Valuation Certificates and Product Ownership Certificates of authenticated purchased products is digitally recorded within the Direct Sales Server Network's database and the customer may be provided with an acknowledgement notice.

Broker Services—After the completion of an authenticated product's purchase, the customer may decide to electronically publish the product within an “Authenticated Valuable Products Resale Catalog”.

The DIAL System will provide its affiliates and members the following Broker Services that include, but are not limited to:
Create and Maintain a catalogue of valuable products
Identified the owner of valuable sought after item
Establish linkage between sellers & buyers
Provide collectible current market product valuations
Establish a numeric rating of the product's owner selling history

In situations where a DIAL client desires to find and purchase a specific authenticated and not counterfeited or pirated product, the DIAL Product Ownership database will be searched to locate the registered owner of the sought after authenticated product. If the product's owner is located within the database, the owner is notified that a purchase request has been entered by another DIAL customer to purchase the product (which may include a buyer's price quote). At that time, the registered owner of the product may choose to ignore the request or accept the request. Should the owner of the product elect to explore the possibility of selling the product to the interest party, the registered owner of the desired product may forward the Dial System's supporting data concerning the authentication and establishment of the product's pedigree, original manufacturing details, retail details, and the registered owner's contact data directly to the buyer.

Should the registered owner of the product agree to sell the item and the buyer agrees to purchase the desired product at an agreed upon purchase price, the “chain of ownership” will be transferred from the seller to the buyer once possession of the authenticated product has been received by the buyer and electronically authenticated. In this situation, an exchange of a products possession will involve the satisfactory completion or compliance of the following, but not limited to:
An authentication challenge “proofing” will be conducted by both the seller prior to shipment and the buyer upon the products delivery. Should both authentication challenges be successful and the transacted product be validated, authenticated, undamaged, and acceptable by the buyer, the registered owner DIAL data records will be transferred from the seller to the buyer for the transacted product. Additionally, the Trust Agency will notify the DIAL affiliated Electronic Payment Service to commence the monetary transaction from the buyer to the seller at the agreed upon price (possibly including shipping & insurance adjustments) in the agreed upon monetary currency. Both parties to the transaction are notified by the DIAL system once the funds have been exchanged.

Performance of Broker Services of authenticated purchased products is digitally recorded within the Direct Sales Server Network's database and the owner of the purchased product may be provided with an acknowledgement notice.

At that time, all Product Appraisal Service data, Product Valuation Certificate data and Product Ownership Certificate data, etc. will be updated to accurately reflect the product's ownership change and the buyer (new owner) of the product may order revised copies of the aforementioned product's Appraisal, Valuation, and Ownership etc. certificate and documents.

Also, previously described DIAL Incentive Offers and services such as: Owner Registration, Rebate Filings, Product Service Plans, Product Performance Insurance Plans, Automatic Periodic Product Ordering Agreement, Collateralization Services, Product Valuation and Certification Services, Broker Services, Electronic Payment Services, etc. may be offered from the Retailers to the newly identified owner of the brokered product.

Direct Incentive Authentication Link Post Purchase Offer Availability—Dial System customers may take advantage of a Retailer's Direct Incentive Authentication Link's Incentive offer after an authenticated product had been purchased and the customer had elected not to take advantage of the Incentive Offer that was offered to them at the time of purchase. To qualify for, revive or resuscitate and accept a previously extended Incentive Offer, the customer can access their authenticated purchase history and select the product that was purchased representing the refused DIAL incentive offer and submit an Incentive Offer Revival Request either on their authenticated cellular telephone, Computer System, or DIAL System authorized electronic device. A revived DIAL Incentive Offer will garner the same authentication processes and safeguards detailed above as well as the DIAL Systems additional services offered on behalf of the Retailers, as appropriate, including, but not limited to: Owner Registration, Product Delivery Scheduling, Rebate Filings, Product Service Plans, Product Performance Insurance Plans, Electronic Product Appraisal Services, External Product Appraisal Services, Automatic Periodic Product Ordering Agreement, Collateralization Services, Product Valuation and Certification Services, Broker Services, Electronic Payment Services, etc.

Should the customer decide to avail themselves to one or several of the previously extended Retailer's DIAL Incentive Offers, the Retailers may send associated “free or bonus items” directly to the customer's address. Acceptance of a DIAL Post Purchase Offer and its ultimate fulfillment is digitally recorded within the Direct Sales Server Network's database and the customer may be provided with an acknowledgement notice.

We claim:

1. A computerized network system encompassing “The Direct Incentive Authentication Link System” that establishes a real-time direct communication link between a user/customer and a product's Manufacturer, Retailer, Credit Card Company, or Distributor (as “Retailers”) during the purchase process within any type of retail environment that transmits, conveys, displays, prompts, notifies, presents to said user/customer an “Incentive Offer” as an inducement to enact a purchase transaction, request a service, or perform a requested associated action based upon the exchange of data between the “Retailers” and user/customer using said telecommunication or computerized electronic device equipped with a reader/interrogator capable of reading and or interacting with a products electronic identification data that currently exits as a Radio Frequency Identification (RFID) tag or similar transponder, and or barcode tags, near-field contact tags, motes, or any future electronic product identification scheme functioning in a similar capacity and said product(s) has been authenticated under the auspices of the ‘Security authentication system for collectible and consumer items’ (patent application Ser. No. 11/157,282) system.

2. A cellular phone wherein said cellular telephone or similar electronic telecommunication device that includes a RFID tag reader or similar reader/interrogator and application software to communicate via a secure authenticated communication link to the “Direct Incentive Authentication Link System” whereas said cellular telephone provides access to an authorization service wherein the said authorization service authenticate said RFID tag and transmits corresponding authorized and authenticated “Retailer” data to the user's/customer's cellular telephone as an incentive or inducement to prompt the user/customer to enact a purchase transaction, request a service, or perform a requested associated action based upon the exchange of data between the “Retailers” and customers using said cellular telephone or similar telecommunication device in a manner consistent with the authentication and security provisions contained within the “Secure RFID Authentication System using non-trusted communications agents” (U.S. patent application Ser. No. 11/728,792) and “Secure RFID Authentication System” (U.S. patent application Ser. No. 11/268,162), both filed by Michael Kulakowski and Robert Kulakowski.

3. A set of “The Direct Incentive Authentication Link System” communication inducements, advertising messages, incentive offers, data prompts, or data details that convey to the user/customer a “Retailer” provider incentive, inducement or advertising campaign directly to the customer to enact a purchase transaction, request a service, or perform a requested associated action based upon the exchange of related data between the “Retailers” and user/customer that corresponds directly to the product(s) the user has been “read via a reader/interrogator, and has been authenticated under the auspices of the ‘Secure authentication system for collectible and consumer items’ (U.S. patent application Ser. No. 11/157,282) system” whereas said communication inducements, advertising messages, incentive offers, data prompts, or data details can be enacted by the user/customer at a particular starting date and time and selected or enacted upon at a later date and time.
